(19) United States
(12) Patent Application Publication
(10) Pub. No.: US 2007/0125822 A1
(43) Pub. Date: Jun. 7, 2007

(54) Firing mechanism of a nailing machine

(76) Inventor: Chung-Ho Liu, Taichung County (TW)

Correspondence Address: TROXELL LAW OFFICE PLLC, 5205 LEESBURG PIKE, SUITE 1404, FALLS CHURCH, VA, 22041, US

(21) Appl. No.: 11/294,837

(22) Filed: Dec. 7, 2005

(51) Int. Cl. B25C 1/04

(52) U.S. Cl. 227/8; 227/130

(57) ABSTRACT

A firing mechanism of a nailing machine with a gun body and a nail cartridge having a telescopic safety member mounted on a front part of a gun barrel and coupled with a push bar within a fixing sleeve disposed at the bottom of a gas chamber whereby the displacement of the push bar permits a contact with a compression tongue of a trigger unit to proceed with a discharge process. An arched slot is correspondingly provided in a groove at both sides of the trigger unit. The compression tongue is pivotally connected to the trigger unit by a hidden displaceable pivot pin that is movable along the arched slot. The movement of the pivot pin along the arched slot of the trigger unit allows an adjustment of the contact area of the compression tongue to the push bar, thereby achieving a continuous discharge mode or a single discharge mode.

### BACKGROUND OF THE INVENTION

1. Fields of the Invention

The invention relates to a firing mechanism of a nailing machine, and more particularly, to a firing apparatus that employs a simple measure to allows a convenient shift between single and continuous discharge modes, thereby maximizing the application effect.

2. Description of the Related Art

It is learned that the setting of the single and continuous discharge of the conventional nailing machine is determined by the amount of the contact area between the telescopic safety member and the compression tongue. As shown in FIG. 10, a prior art developed by the same inventor of the invention includes a telescopic safety member 10 with a push bar 11 at the rear end of thereof. The displacement of the push bar 11 allows a contact to a compression tongue 13 of a trigger unit 12 for conducting a firing process. An arched slot 14 is correspondingly provided near the bottom at both sides of the trigger unit 12. The compression tongue 13 is pivotally connected to the trigger unit 12 by a displaceable pivot pin 15 that is movable along the arched slot 14. The movement of the pivot pin 15 between the top to the bottom of the arched slot 14 of the trigger unit 12 permits an adjustment of the contact area of the compression tongue 13 to the push bar 11, thereby achieving a continuous discharge mode or a single discharge mode.

However, the above-mentioned configuration still has drawbacks. In order to achieve a smooth displacement of the pivot pin 15, the pivot pin 15 has to own a larger total length than the width of the trigger unit 12, thereby resulting in holding discomfort of the finger of the operator. In other words, when the finger is hooked in the trigger unit 12, the protrusion of the pivot pin 15 will touch the operator's finger, thereby causing the discomfort of the finger.

### SUMMARY OF THE INVENTION

A primary object of the invention is to eliminate the above-mentioned drawbacks and to provide a firing mechanism of a nailing machine that employs a pivot pin hidden within the breadth of the trigger unit. Meanwhile, the pivot pin includes a staged groove. Accordingly, the pivot pin can be deliberately forced into a transitional hole of the arched slot by means of the diametric difference between a spring and the arched slot for changing the operating modes. After completing the changing operation, the pivot pin exposed to the resilience of the spring can be returned to its engaged position, thereby preventing the pivot pin from undesirable sliding action. In this way, the operational safety can be considerably enhanced.

### BRIEF DESCRIPTION OF THE DRAWINGS

The accomplishment of this and other objects of the invention will become apparent from the following description and its accompanying drawings of which:

FIG. 1 is a partial exploded view of the invention in section;

FIG. 2 is a perspective view of the trigger unit of the invention after assembly;

FIG. 3 is a sectional view of the invention in continuous discharge mode;

FIG. 4 is a sectional view of the invention in accordance with FIG. 3, showing the operation thereof;

FIG. 5 is a sectional view of the invention in accordance with FIG. 3, showing a continuous operation thereof;

FIG. 6 is a sectional view of the invention in a single discharge mode;

FIG. 7 is a sectional view of the invention in accordance with FIG. 6, showing the operation thereof;

FIG. 8 is a sectional view of the invention in accordance with FIG. 6, showing a continuous operation thereof;

FIG. 9 is a schematic drawing of the invention in accordance with FIG. 6, showing that the push bar and the compression tongue are out of action when first the trigger unit and then the telescopic member are compressed; and

FIG. 10 is a partial exploded view of the prior art.

### DETAILED DESCRIPTION OF THE PREFERRED EMBODIMENT

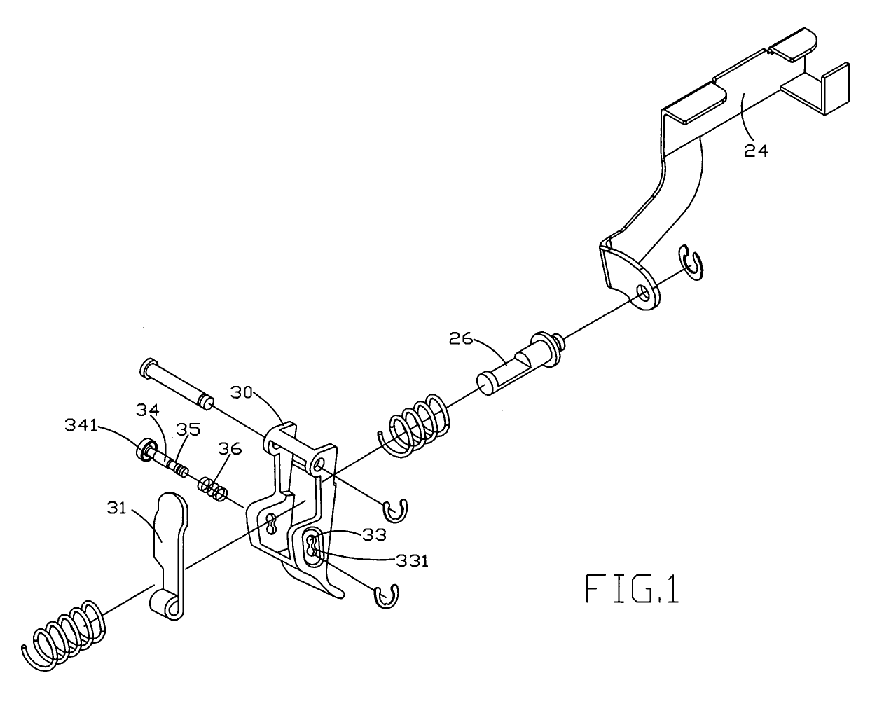

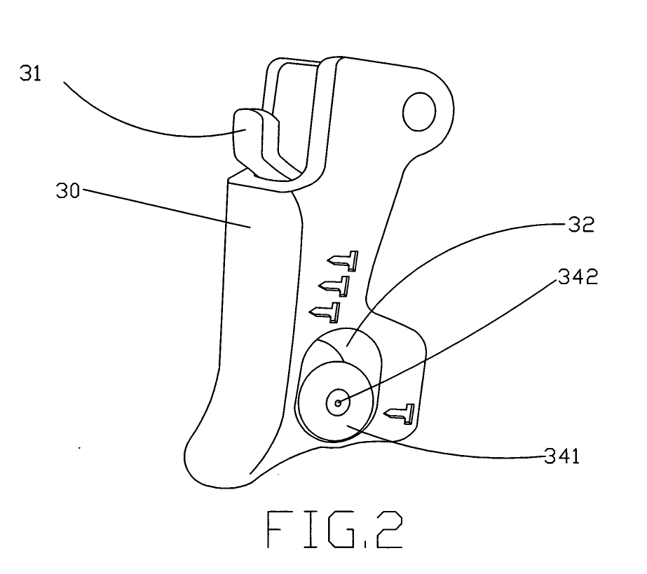

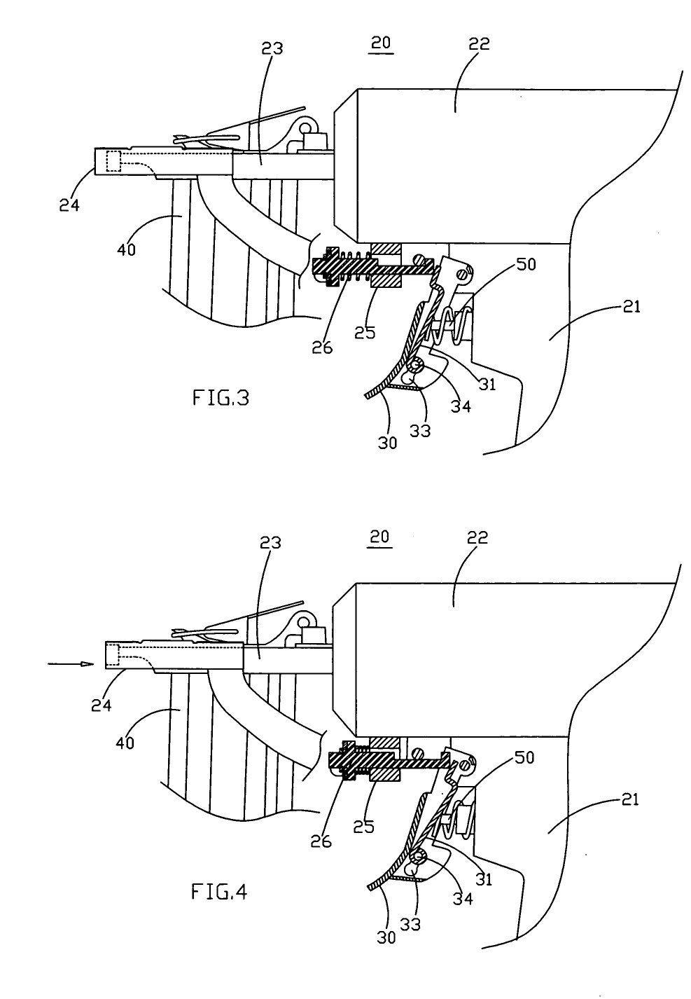

Referring to FIGS. 1 and 2, a firing mechanism of a nailing machine in accordance with the invention includes a gun body 20 and a nail cartridge 40.

The gun body 20 includes a handle 21 and an air chamber 22. A gun barrel 23 is provided at a front end of the air chamber 22. A telescopic safety member 24 is mounted on a front part of the gun barrel 23 and coupled with a push bar 26 within a fixing sleeve 25 disposed at the bottom of the gas chamber 22. The displacement of the push bar 26 permits a contact with a compression tongue 31 of a trigger unit 30 to proceed with a discharge process.

The nail cartridge 40 is disposed at right angles to the gun barrel 23. A plurality of nails (not shown) received within the nail cartridge 30 can pass through an open groove (not shown) at the bottom of the gun barrel 23 and enter into the gun barrel 23 for a nailing process.

An arched slot 33 is correspondingly provided in a groove 32 at both sides of the trigger unit 30. The compression tongue 31 is pivotally connected to the trigger unit 30 by a hidden displaceable pivot pin 34 that is movable along the arched slot 33. The movement of the pivot pin 34 between the top and the bottom of the arched slot 33 of the trigger unit 30 allows an adjustment of the contact area of the compression tongue 31 to the push bar 26, thereby achieving a continuous discharge mode or a single discharge mode.

The pivot pin 34 includes a staged groove 35. Accordingly, the pivot pin 34 can be deliberately forced into a transitional hole 331 of the arched slot 33 by means of the diametric difference between a spring 36 and the arched slot 33 for changing the operating modes. After completing the changing operation, the pivot pin 34 exposed to the resilience of the spring 36 can be returned to its engaged position, thereby preventing the pivot pin 34 from undesirable sliding action.

As shown in FIG. 2, the head 341 of the pivot pin 34 is provided with a groove 342 so that a nib of a pen, a nail, a screwdriver, etc. can replace the finger in respect of a smooth compression of the pivot pin 34. Moreover, an antislip riffle (not shown) is formed on the head 341 of the pivot pin 34 to allow the user to push the pivot pin 34 smoothly.

FIGS. 4 and 5 illustrate the continuous discharge mode of the invention. It's apparent from FIGS. 4 and 5 that the compression tongue 31 is sufficiently extended in contact with the push bar 26. After the single discharge process, the compression tongue 31 remains in contact with the push bar 26 if the trigger unit 30 is not released or the telescopic safety member 24 is not returned to its original position. So, the discharge tappet 40 remains in compressed state to allow the performance of continuous discharge when the operator holds down the trigger unit 30 again or compresses the telescopic safety member 24 continuously.

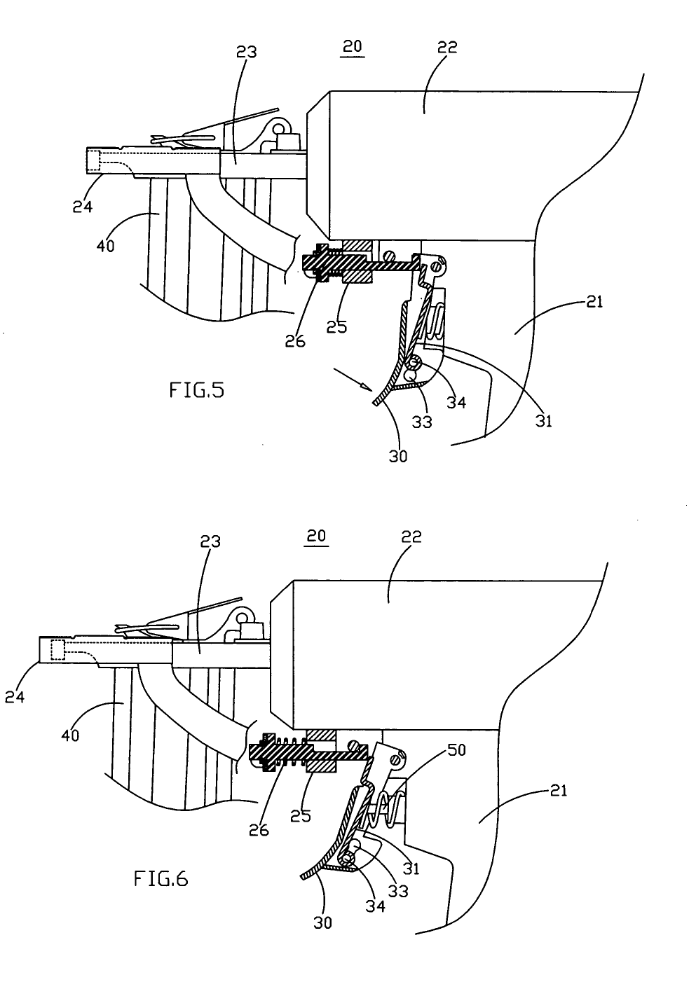

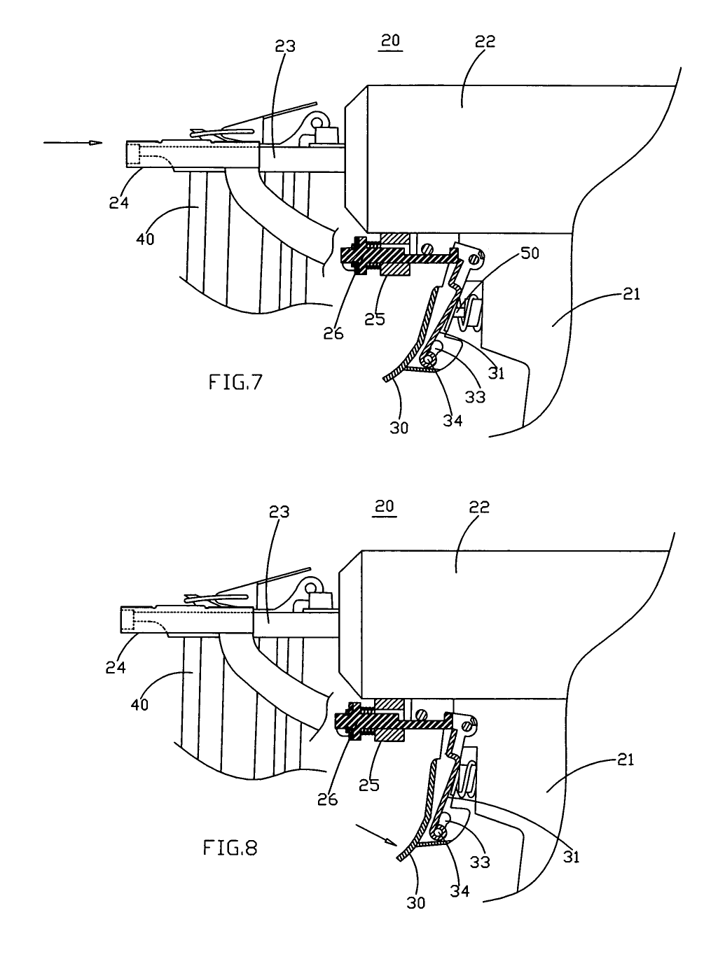

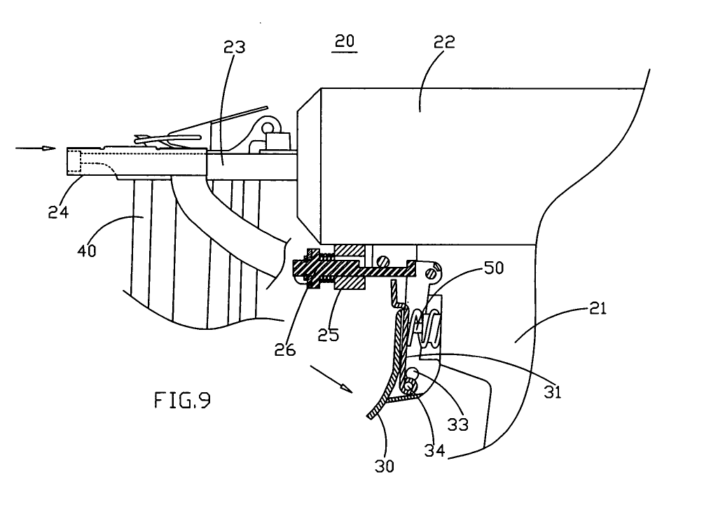

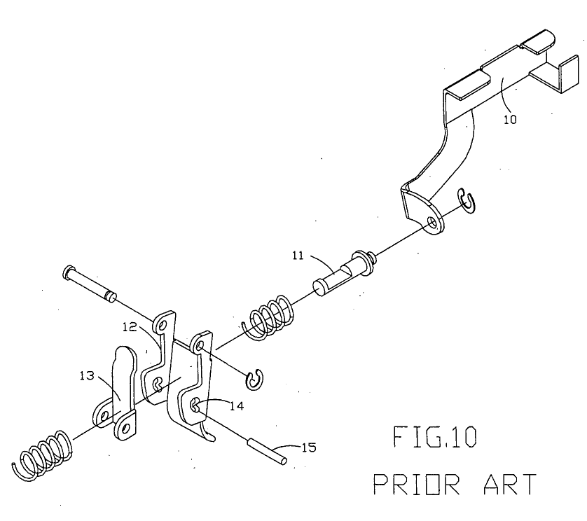

In order to shift the compression tongue 28 to the position of the single discharge mode, the pivot pin 34 has to be moved downward to a lower section of the arched slot 33 of the trigger unit 30, as shown in FIGS. 6 through 9. In this operational mode, only the free end of the compression tongue 31 is slightly extended in contact with the push bar 26. So, the compression tongue 31 will be detached from the push bar 26 due to difference in height after completion of the single discharge process. Meanwhile, the discharge tappet 50 will be automatically extended outwards. Unless the operator releases the trigger unit 30 to allow the push bar 26, the compression tongue 31, and the telescopic safety member 24 to return back to their original position or, the push bar 26 doesn't contact with the compression tongue 31 to trigger the discharge tappet 50 for continuous nailing process (see FIG. 9).

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

1. A firing apparatus of a nailing gun having a gun body and a nail cartridge, the firing apparatus comprising:
a) a telescopic safety member mounted on a front part of a gun barrel and coupled with a push bar within a fixing sleeve disposed at the bottom of a gas chamber whereby the displacement of the push bar permits a contact with a compression tongue of a trigger unit to proceed with a discharge process, and
b) an arched slot correspondingly provided in a groove at both sides of the trigger unit, the arched slot having a top opening and a bottom opening separated by a tapered middle opening narrower than both the top opening and the bottom opening, the compression tongue being pivotally connected to the trigger unit by a non-protruding displaceable pivot pin that is movable along the arched slot, the movement of the pivot pin between the top opening and the bottom opening of the arched slot of the trigger unit allowing an adjustment of the contact area of the compression tongue to the push bar, thereby achieving a continuous discharge mode or a single discharge mode.

2. The firing mechanism of a nailing machine as claimed in claim 1 wherein the pivot pin includes a staged groove forming a substantially flat surface on an outer surface of the pivot pin, and wherein the pivot pin can be deliberately forced into a transitional hole of the arched slot by means of the diametric difference between a spring and the arched slot for changing of the operating modes, and wherein after completing the changing of the operating modes, the pivot pin can be returned to an engaged position through a force from the spring.

3. The firing mechanism of a nailing machine a claimed in claim 1 wherein a head of the pivot pin is provided with a groove.
